(19) United States
(12) Patent Application Publication
(10) Pub. No.: US 2009/0327564 A1
(43) Pub. Date: Dec. 31, 2009

(54) Method and apparatus of implementing control and status registers using coherent system memory

(76) Inventor: Nagabhushan Chitlur, Portland, OR (US)

Correspondence Address: INTEL CORPORATION;c/o CPA Global, P.O. BOX 52050, MINNEAPOLIS, MN, 55402, US

(21) Appl. No.: 12/217,089

(22) Filed: Jun. 30, 2008

(51) Int. Cl. G06F 13/14

(52) U.S. Cl. 710/305

(57) ABSTRACT

In some embodiments control and status registers of a coherent Input/Output device coupled to a host system bus are mapped to a system memory. Direct memory access is provided to the memory mapped control and status registers in the system memory by a CPU that is coupled to the host system bus. Other embodiments are described and claimed.

### TECHNICAL FIELD

The inventions generally relate to memory mapping of control and status registers (CSRs).

### BACKGROUND

The coherent system bus (and/or host system bus) in computer systems is typically coupled only to Central Processing Units (CPUs) and not to other classes of devices. However, this has been rapidly changing, and Input/Output (I/O) devices are increasingly being directly coupled to the host system bus (for example, via the CPU socket). Host system buses such as, for example, the Front Side Bus (FSB) and the Quick Path Interconnect bus (QPI, previously known as the Common Serial Interconnect and/or CSI), were designed to couple to CPU type devices and not to I/O devices. In the case of some host system buses such as FSB, fundamental primitives required for coupling I/O devices directly to the host system bus do not exist. In the case of other host system buses such as QPI, coupling I/O devices directly to the host system bus currently require significant hardware. An I/O device that is directly coupled to the host system bus is referred to as a coherent I/O (CIO) device. An I/O device such as a CIO device needs to be able to implement Control and Status Registers (CSRs) which are accessible by other agents that are coupled to the CIO device. In order to implement CSRs, the I/O device needs to “own” a small piece of system memory address space via which CPUs can read/write the CSRs implemented in the I/O device.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a system according to some embodiments of the inventions.

FIG. 2 illustrates a system according to some embodiments of the inventions.

FIG. 3 illustrates a system according to some embodiments of the inventions.

FIG. 4 illustrates a system according to some embodiments of the inventions.

FIG. 5 illustrates a flow according to some embodiments of the inventions.

### DETAILED DESCRIPTION

Some embodiments of the inventions relate to memory mapping of control and status registers (CSRs).

In some embodiments control and status registers of a coherent Input/Output device coupled to a host system bus are mapped to a system memory. Direct memory access is provided to the memory mapped control and status registers in the system memory by a CPU that is coupled to the host system bus.

In some embodiments a coherent Input/Output device is coupled to a host system bus. A system memory is to map control and status registers of the coherent Input/Output device, and is to provide direct memory access to the mapped control and status registers.

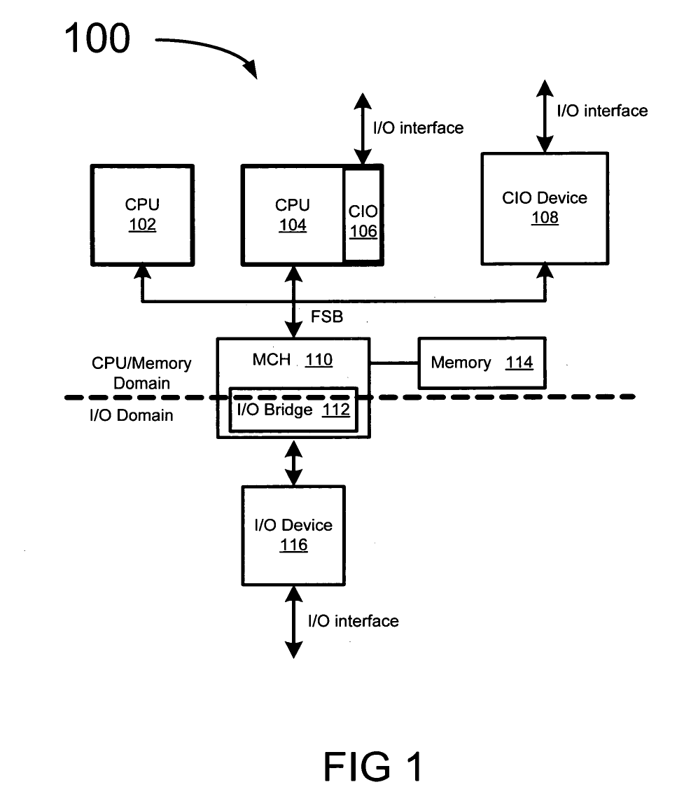

FIG. 1 illustrates a system 100 according to some embodiments. In some embodiments system 100 includes a system architecture in which CIO devices are coupled to CPUs via a host system bus such as a front side bus (FSB). In some embodiments, system 100 includes a CPU 102, a CPU 104 including a coherent I/O device (CIO device) 106, a CIO device 108, a memory controller hub (MCH) 110 including an I/O bridge 112, a system memory 114, and an I/O device 116. System 100 also includes a host system bus such as a front side bus (FSB) that couples CPU 102, CPU 104, CIO device 108 and MCH 110. In some embodiments, MCH 110 is coupled to I/O device 116 via an I/O bus (for example, a Peripheral Component Interconnect or PCI bus, a PCI-X bus, a PCI-E bus, etc.) In some embodiments, CIO device 108 is, for example, a Network Interface Card (NIC), a graphics controller, or some other type of I/O device. In some embodiments, CIO 106, CIO device 108, and I/O device 116 are coupled to respective I/O interfaces. In some embodiments, the elements in FIG. 1 above the dotted line are in a CPU/Memory domain and the elements in FIG. 1 below the dotted line are in an I/O domain.

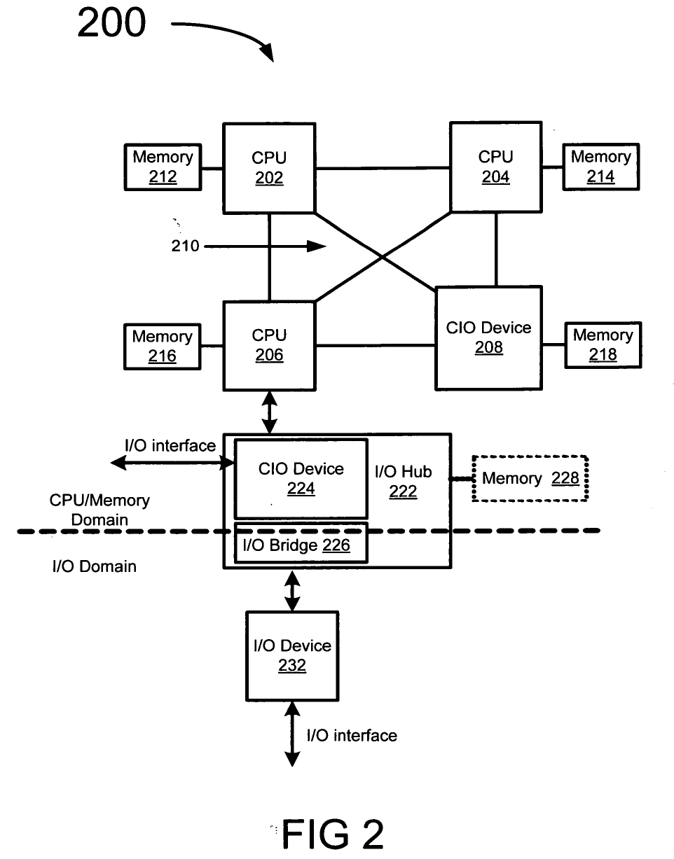

FIG. 2 illustrates a system 200 according to some embodiments. In some embodiments system 200 includes a system architecture in which CIO devices are coupled to CPUs via a host system bus such as a Quick Path Interconnect bus (QPI). In some embodiments, system 200 includes a CPU 202, a CPU 204, a CPU 206, a CIO device 208, a host system bus 210 (for example, a QPI bus), a memory 212, a memory 214, a memory 216, a memory 218, an Input/Output Hub (IOH) 222 including a CIO device 224 and an I/O bridge 226, a memory 228, and an I/O device 232. Host system bus 210 (for example, a CSI fabric) couples CPU 202, CPU 204, CPU 206, and CIO device 208. In some embodiments, IOH 222 is coupled to I/O device 232 via an I/O bus (for example, a Peripheral Component Interconnect or PCI bus, a PCI-X bus, a PCI-E bus, etc.) In some embodiments, CIO device 208 and/or CIO device 224 is/are, for example, a Network Interface Card (NIC), a graphics controller, or some other type of I/O device. In some embodiments, CIO device 224 and I/O device 232 are coupled to respective I/O interfaces. In some embodiments, the elements in FIG. 2 above the dotted line are in a CPU/Memory domain and the elements in FIG. 2 below the dotted line are in an I/O domain.

As discussed above, an I/O device such as a CIO device needs to be able to implement Control and Status Registers (CSRs) which are accessible by other agents connected to the I/O device. In some embodiments, an efficient method of implementing CSRs for a CIO device is performed using only the caching protocol of the CPU(s). This enables an I/O device to be directly coupled to systems of all topologies (for example, in systems using single memory controller architectures such as FSB as well as multiple memory controller architectures such as QPI).

The primary requirement of implementing CSRs is for the I/O device to “own” a small piece of system memory address space via which CPUs can read/write the CSRs implemented in the I/O device. There are difficulties in achieving this for a CIO device. For example, in an FSB type system (for example, with only one MCH) the MCH owns all of the system memory. Thus, a CPU or CIO device does not have the ability to own system memory. Therefore, one CPU cannot directly target accesses to another CPU or CIO device. In this environment, all accesses must happen via system memory or via cache to cache transfers. In a QPI type system (for example, with multiple MCHs) it is possible for the CPU or CIO device to own a part of system memory. However, this is very expensive since a full memory controller must be implemented for the CPU or CIO device. Therefore, according to some embodiments, caching protocols may be used to allow a CIO device to implement CSRs without actually “owning” that address range of system memory.

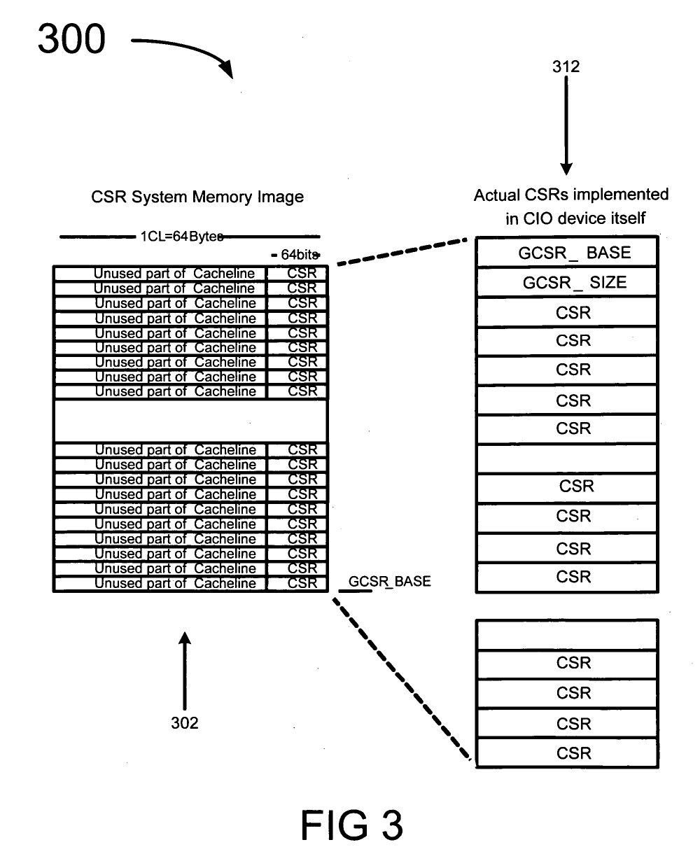

FIG. 3 illustrates a system 300 according to some embodiments. System 300 includes a CSR system memory image 302 and actual CSRs 312 implemented in a CIO device itself. FIG. 3 illustrates the mapping of CSR registers to system memory. A base value of the CSRs (GCSR_BASE) and a size value of the CSRs (GCSR_SIZE) are mapped in the CIO device itself. The CSR system memory image 302 illustrates, for example, for each entry a cache line of 64 Bytes, including an unused part of the cache line and a CSR value of 64 bits.

As illustrated in FIG. 3, the Status and Control Registers (CSRs) of the CIO device 312 are memory mapped to cacheable memory 302. This allows the CPU to access the CSRs via accesses to system memory. The actual CSRs are implemented in the CIO device itself, but the system memory image 302 is also maintained to provide the CPU direct access to the CSRs. The system memory CSR image 302 is kept up to date by the CIO device in order to reflect the latest status of the registers in the hardware device. The region of memory used to map the CSRs is pinned up front and does not change until a reset event occurs.

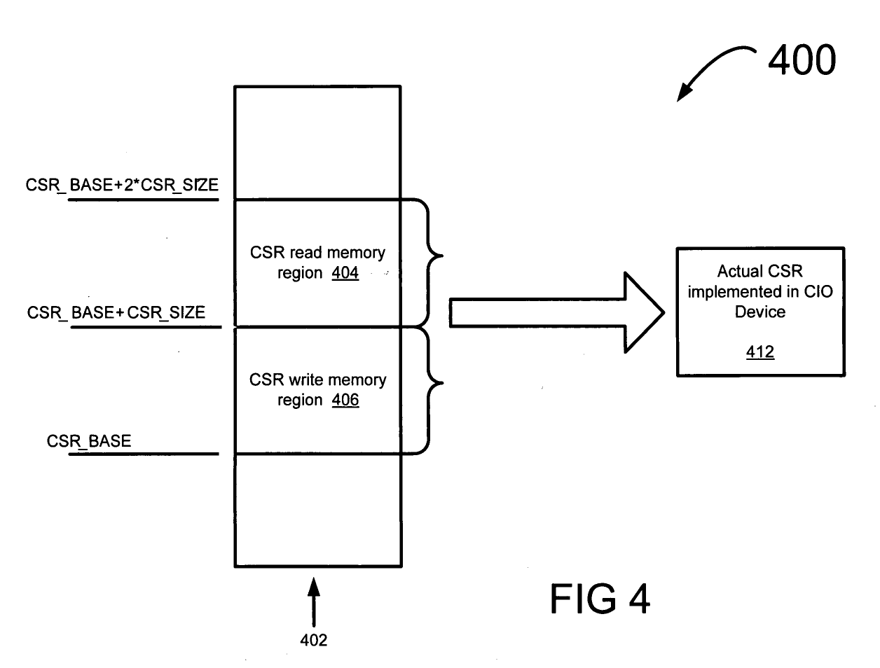

FIG. 4 illustrates a system 400 according to some embodiments. System 400 includes a CSR image 402 in system memory including a CSR read memory region 404 and a CSR write memory region 406, as well as the actual CSR 412 implemented in the CIO device. As shown in FIG. 4, for example, CSR write memory region 406 extends from system memory address CSR_BASE to system memory address CSR_BASE+CSR_SIZE, and CSR read memory region 404 extends from system memory address CSR_BASE+CSR_SIZE to system memory address CSR_BASE+2*CSR_SIZE.

FIG. 4 illustrates the mapping of CSRs (for example, hardware CSRs) into two system memory address ranges, one of which is used to read CSRs (406) and the other used to write CSRs (404). As illustrated in FIG. 4, a single set of CSRs are memory mapped using the two address ranges 404 and 406. This allows the CIO device to identify the type of access (that is, a read access or a write access) based only on the system memory address.

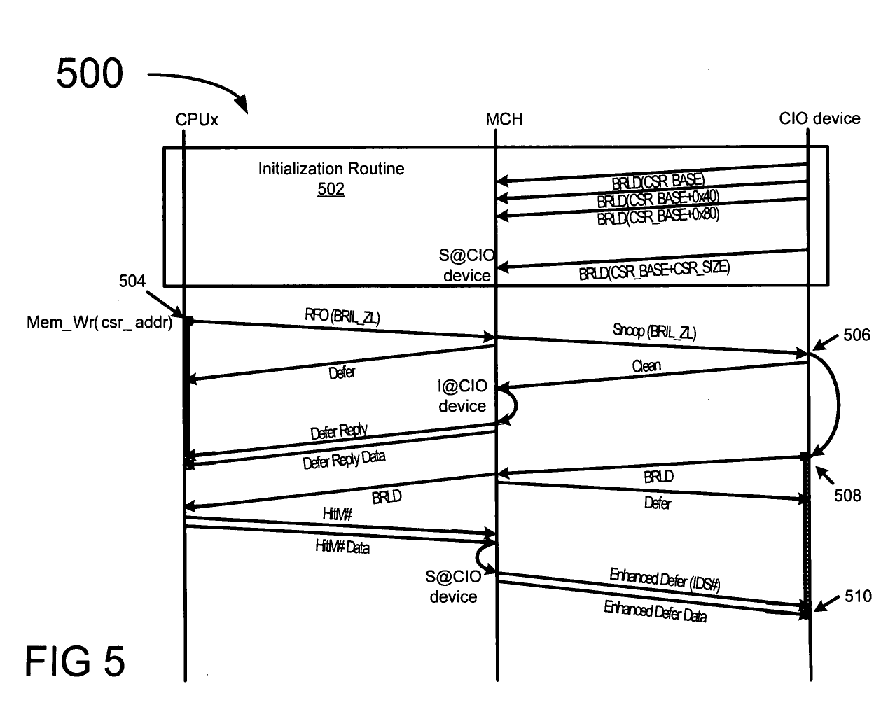

FIG. 5 illustrates a flow 500 according to some embodiments. Flow 500 illustrates a CSR write flow between a CPU (CPUx), an MCH and a CIO device. Flow 500 illustrated in FIG. 5 is a detailed flow for an implementation on an FSB platform, but is also representative of a flow that may be used for other platforms as well (for example, for a QPI platform).

At 502 an initialization routine is performed in which the CIO device reads every cacheline BRLD(CSR_BASE), BRLD(CSR_BASE+0x40), BRLD(CSR_BASE+0x80), . . . , BRLD(CSR_BASE+CSR_SIZE) in the CSR write memory region of the system memory. Then the snoopfilter state at the MCH is S@CIO device for all cachelines in the CSR write memory region.

The primary problem with implementing a CSR write mechanism is that the CPU writes to the system memory image, but does not necessarily indicate to the CIO device that a write has occurred. In some embodiments, in order to ensure that the CIO device is aware that a CSR write has occurred is to ensure that a snoop is sent to the CIO device every time the CPU writes a CSR (for example, at 504 in FIG. 5). A snoop is then sent to the CIO device and it can then look at the address of the snoop at 506 and determine if the cause of the snoop was originally due to a read or a write transaction by the CPU. At 506 the CIO device will receive a snoop even if the MCH snoopfilter is turned on, since the line is in the “S” state. In any case, if the address indicates that the snoop is to the CSR write memory region the CIO device concludes that the CPU has written to the CSR. The CIO device then reads the corresponding address in system memory (for example, by issuing a BRLD at 508) and updates its hardware CSR with the returned value at 510, thus achieving a CPU write to the CIO CSR.

In some embodiments, a CIO device reads the CSR by reading the image in system memory. The CIO device is not aware of this action as it targets only the system memory image. It is the responsibility of the CIO device to keep the CSR image in system memory up to date by updating the memory image as and when a CSR changes in hardware.

In some embodiments, CSRs are implemented for I/O devices directly coupled to a host system bus (for example, directly coupled to an FSB or a QPI). According to some embodiments, the added burden of building an additional memory controller for the CIO device in the system is not necessary. In some embodiments, a mechanism for updating CSRs may be implemented across all current and future host system interconnects by implementing principles of cache and coherency. In some embodiments, CSRs may be updated in systems using node controllers. In some embodiments, CPU sockets are enabled to be used for coupling high performance I/O devices that make use of coherency. In some embodiments, cache coherent I/O devices may be directly coupled to a coherent system interconnect (for example, such as FSB, QPI, etc.) In some embodiments, a simple implementation may be used for CSRs which takes advantage of access to high performance coherent transactions available only to the CPU. In some embodiments, I/O devices are fully cache coherent and also efficient, thus eliminating the use of low performance transactions such as MMIO (Memory-mapped I/O) transactions.

Although some embodiments have been described herein as being implemented in an FSB and/or QPI environment, according to some embodiments these particular implementations are not required, and embodiments implemented in other architectures may be implemented.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A method comprising:
mapping to system memory control and status registers of a coherent Input/Output device coupled to a host system bus; and
providing direct memory access to the memory mapped control and status registers in the system memory by a CPU that is coupled to the host system bus.

2. The method of claim 1, wherein the mapping includes mapping a single set of control and status registers of the coherent I/O device using a first memory region of the system memory to read from the control and status registers and using a second memory region of the system memory to write to the control and status registers.

3. The method of claim 2, further comprising reading the mapped control and status registers from the first memory region and writing the mapped control and status registers from the second memory region.

4. The method of claim 1, further comprising writing to the mapped control and status registers in system memory.

5. The method of claim 4, further comprising sending a snoop to the coherent Input/Output device in response to the writing.

6. The method of claim 5, further comprising reading data written to the mapped control and status registers in the system memory in response to the snoop.

7. The method of claim 6, further comprising updating control and status registers of the coherent Input/Output device in response to the reading.

8. The method of claim 1, further comprising updating the mapped control and status registers in system memory when a control and status register changes at the coherent Input/Output device.

9. The method of claim 2, further comprising writing to the mapped control and status registers in system memory by writing to the second memory region.

10. The method of claim 9, further comprising sending a snoop to the coherent Input/Output device in response to the writing.

11. The method of claim 10, further comprising reading data written to the mapped control and status registers in the second memory region of the system memory in response to the snoop.

12. The method of claim 11, further comprising updating control and status registers of the coherent Input/Output device in response to the reading.

13. The method of claim 2, further comprising updating the mapped control and status registers in the first memory region and in the second memory region of system memory when a control and status register changes at the coherent Input/Output device.

14. An apparatus comprising:
a coherent Input/Output device coupled to a host system bus;
a system memory to map control and status registers of the coherent Input/Output device, and to provide direct memory access to the mapped control and status registers.

15. The apparatus of claim 14, wherein the system memory is to provide the direct memory access to the mapped control and status registers to a CPU that is coupled to the host system bus.

16. The apparatus of claim 14, wherein the system memory includes a control and status register read memory region and a control and status register write memory region, the system memory to map a single set of control and status registers of the coherent I/O device using the control and status register read memory region and using the control and status register write memory region.

17. The apparatus of claim 16, wherein the system memory is to allow a CPU that is coupled to the host system bus to read the mapped control and status registers from the first memory region and write the mapped control and status registers from the second memory region.

18. The apparatus of claim 14, the system memory to allow a CPU coupled to the host system bus to write to the mapped control and status registers in system memory.

19. The apparatus of claim 18, the coherent Input/Output device to receive a snoop in response to writing of the mapped control and status registers in system memory.

20. The apparatus of claim 19, the coherent Input/Output device to read data written to the mapped control and status registers in the system memory in response to the snoop.

21. The apparatus of claim 20, the coherent Input/Output device to update control and status registers of the coherent Input/Output device in response to the read data.

22. The apparatus of claim 14, the coherent Input/Output device to update the mapped control and status registers in system memory when a control and status register changes at the coherent Input/Output device.

23. The apparatus of claim 16, the system memory to allow a CPU coupled to the host system bus to write to the mapped control and status registers in system memory by writing to the control and status register write memory region.

24. The apparatus of claim 23, the coherent Input/Output device to receive a snoop in response to writing to the second memory region.

25. The apparatus of claim 24, the coherent Input/Output device to read data written to the mapped control and status registers in the control and status register write memory region in response to the snoop.

26. The method of claim 25, the coherent Input/Output device to update control and status registers of the coherent Input/Output device in response to the read data.

27. The apparatus of claim 16, the coherent Input/Output device to update the mapped control and status registers in the control and status read memory region and in the control and status write memory region when a control and status register changes at the coherent Input/Output device.
